(19) United States
(12) Patent Application Publication
(10) Pub. No.: US 2005/0010650 A1
(43) Pub. Date: Jan. 13, 2005

(54) Network-based computer platform external access method and system

(76) Inventor: Ying-Chuan Tsai, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/618,929

(22) Filed: Jul. 11, 2003

(51) Int. Cl. G06F 15/16

(52) U.S. Cl. 709/219

(57) ABSTRACT

A network-based computer platform external access method and system is proposed, which is designed for use with a computer platform, especially with an I/O-unequipped computer platform, such as a network server, for the externally controlling the operations of the I/O-unequipped computer platform and monitoring responses from the same. The proposed method and system normally allows the user to gain access to the I/O-unequipped computer platform either in manual mode or auto mode. In auto mode, it allows the user to perform an externally-monitored auto test procedure on the I/O-unequipped computer platform by downloading a test-procedure description file via a network system from a server to test the internal hardware/software configurations of the I/O-unequipped computer platform. These features allow-the network system management personnel to perform network management tasks on the I/O-unequipped network server more conveniently and efficiently.

### BACKGROUND OF THE INVENTION

1. Field of the Invention

This invention relates to network-based information technology, and more particularly, to a network-based computer platform external access method and system, which is designed for use with a computer platform, especially with an I/O-unequipped computer platform that has no I/O devices like monitor and keyboard, such as a network server or a process controller, for the purpose of externally controlling the operations of the I/O-unequipped computer platform and monitoring responses from the same, such as performing an externally-monitored test procedure on the I/O-unequipped computer platform.

2. Description of Related Art

A PC (personal computer) is typically equipped with a set of I/O (input/output) devices, including, for example, a keyboard, a monitor, and a pointing device (mouse, track ball, touchpad, etc.), for the user to control the operations of the PC for such tasks as using application programs, system management, upgrading, file maintenance, hardware testing and maintenance, and so on.

In a network system, a PC is often utilized as a server of various purposes, such as Web page server, file server, data storage server, email server, to name just a few. When a PC is utilized as a server, its I/O devices are typically removed after all system resources have been installed to the PC via the I/O devices since the I/O devices are usually unnecessary during the operation of the server. Therefore, in order to save equipment cost and space, a network server is often equipped with no I/O devices.

However, when the network system management personnel needs to test, maintain, upgrade, or modify a server's internal hardware/software configurations, it would be a problem for the network system management personnel to perform these tasks on the I/O-unequipped server since I/O devices are required to input commands and monitor responses to and from the server.

### SUMMARY OF THE INVENTION

It is therefore an objective of this invention to provide a network-based computer platform external access method and system that can be used with an I/O-unequipped computer platform, such as a network server, to allow the network system management personnel to externally control the operations of the computer platform and monitor the responses from the same.

It is another objective of this invention to provide a network-based computer platform external access method and system that allows the network system management personnel to perform network management tasks on an I/O-unequipped network server more conveniently and efficiently.

The network-based computer platform external access method and system according to the invention is designed for use with a computer platform, especially with an I/O-unequipped computer platform that has no I/O devices like monitor and keyboard, such as a network server or a process controller, for the purpose of externally controlling the operations of the computer platform and monitoring responses from the same such as performing an externally-monitored test procedure on the computer platform.

The network-based computer platform external access method and system according to the invention normally allows the user to perform externally-accessed control or test operations on the computer platform; and when it is required to test the internal hardware/software configurations of the computer platform, the invention allows user to perform an externally-monitored auto test procedure on the computer platform by downloading a test procedure description file via a network system from a server for the purpose of automatically testing the internal hardware/software configurations of the computer platform. These features allow the network system management personnel to perform network management tasks on the I/O-unequipped network server more conveniently and efficiently.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the network-based computer platform external access system according to the invention; and

FIG. 2 is a flow diagram showing the procedural steps performed by the network-based computer platform external access system according to the invention.

### DETAILED DESCRIPTION OF PREFERRED EMBODIMENTS

The network-based computer platform external access method and system according to the invention is disclosed in full details by way of preferred embodiments in the following with reference to the accompanying drawings.

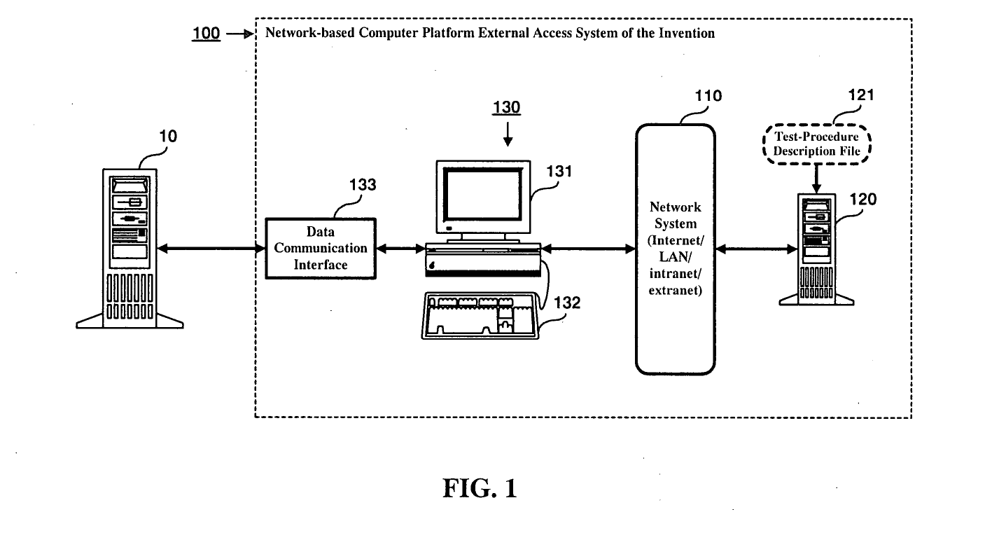

FIG. 1 is a schematic diagram showing the system architecture of the network-based computer platform external access system (as the part enclosed in the dotted box indicated by the reference numeral 100) according to the invention. As shown, in application, the network-based computer platform external access system of the invention 100 is linked to a computer platform 10, especially an I/O-unequipped computer platform equipped with no I/O devices like monitor and keyboard, such as a network server or a process controller, for the purpose of externally controlling the operations of the computer platform 10 and monitoring responses from the same, such as performing an externally-monitored test procedure on the computer platform 10.

As shown in FIG. 1, the network-based computer platform external access system of the invention 100 comprises: (a) a network system 110; (b) a server 120; and (c) a terminal monitoring platform 130.

The network system 110 can be the Internet, a LAN system, an intranet system, or an extranet system, which is linked between the server 120 and the terminal monitoring platform 130 to allow them to exchange data via the network system 110.

The server 120 is linked to the network system 110 to serve up a procedure description file 121, such as a test-procedure description file which contains a sequence of user-predefined sequence of test procedures, via the network system 110 to any client such as the terminal monitoring platform 130.

The terminal monitoring platform 130 is an I/O-equipped computer platform that is equipped with at least one monitor 131 and one keyboard 132, and which is further equipped with a data communication interface 133, such as a serial interface, a parallel interface, or a USB (Universal Serial Bus) interface, for external linking to the computer platform 10. Moreover, the terminal monitoring platform 130 is capable of linking via the network system 110 to the server 120 for downloading the procedure description file 121 from the server 120 when it is required to perform an auto test procedure on the computer platform 10.

Normally, the network-based computer platform external access system of the invention 100 allows the user to externally control the operations of the computer platform 10 via the monitor 131 and the keyboard 132 on the terminal monitoring platform 130, i.e., the user can use the keyboard 132 to input commands which are then transferred via the data communication interface 133 to the computer platform 10 to command the computer platform 10 to operate accordingly; and when it is required to test the internal hardware/software configurations of the computer platform 10, the user can link the terminal monitoring platform 130 via the network system 110 to the server 120 to download the procedure description file 121 from the server 120 to the terminal monitoring platform 130 where each user-predefined command in the procedure description file 121 is sent via the data communication interface 133 to the computer platform 10 and the response of the computer platform 10 is sent back via the data communication interface 133 to the terminal monitoring platform 130, allowing the user to view the test result via the monitor 131 on the terminal monitoring platform 130.

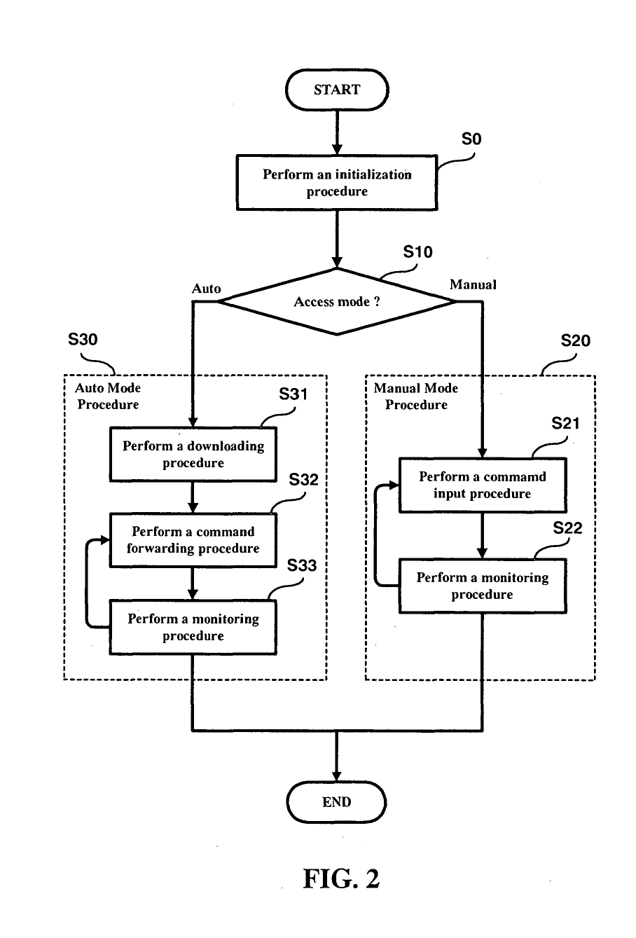

FIG. 2 is a flow diagram showing the procedural steps performed by the network-based computer platform external access system of the invention 100.

Referring to FIG. 2 together with FIG. 1, the first step SO is to perform an initialization procedure to initialize the terminal monitoring platform 130 for establishing a data communication link between the terminal monitoring platform 130 and the computer platform 10 via the data communication interface 133.

The next step S10 is to perform an access mode selection procedure, wherein the terminal monitoring platform 130 is activated to prompt the user to select between a manual mode and an auto mode of operation; wherein the manual mode allows the user to manually control the operations of the computer platform 10 via the terminal monitoring platform 130, while the auto mode will activate the terminal monitoring platform 130 to automatically download the procedure description file 121 via the network system 110 from the server 120 for the purpose of performing an externally-monitored auto test procedure on the computer platform 10. If manual mode is selected, the procedure goes to the step S20; and if auto mode is selected, the procedure goes to the step S30.

The step S20 of manual mode procedure further includes two substeps S21 and S22, a first substep S21 of command-input procedure and a second substep S22 of monitoring procedure.

The first substep S21 is to perform a command-input procedure, wherein the terminal monitoring platform 130 is activated to prompt the user to input commands via the keyboard 132, and then transfer the user-input commands via the data communication interface 133 to the computer platform 10, thus commanding the computer platform 10 to operate accordingly.

In the next substep S22, the terminal monitoring platform 130 is activated to perform a monitoring procedure, wherein the computer platform 10 is requested to transfer the response to each user-input command back via the data communication interface 133 to the terminal monitoring platform 130 to be displayed on the monitor 131 for the user to view the response to each user-input command. If further operations are required, the procedure is returned to the foregoing substep S21 and repeat the command-input procedure and the monitoring procedure again, until all the user-initiated manual operations on the computer platform 10 are completed.

On the other hand, the step S20 of auto mode procedure includes three substeps S31, S32, and S32.

The first substep S31 is to perform a downloading procedure, wherein the terminal monitoring platform 130 is activated to link via the network system 110 to the server 120 to download the procedure description file 121 from the server 120. The procedure description file 121 can be, for example, a test-procedure description file that contains a sequence of user-predefined sequence of commands that are used to test the internal hardware/software configurations of the computer platform 10.

The next substep S32 is to perform a command forwarding procedure, wherein the terminal monitoring platform 130 is activated to forward each command or test procedure in the procedure description file 121 via the data communication interface 133 to the computer platform 10 where the command or test procedure is executed to test the internal hardware/software configurations of the computer platform 10. After each test procedure is completed, the computer platform 10 will transfer a result message, such as “PASS” or “FAIL”, via the data communication interface 133 back to the terminal monitoring platform 130 to be displayed on the monitor 131 for viewing by the user whether the computer platform 10 is normal or abnormal.

The next substep S33 is to perform a monitoring procedure, wherein the terminal monitoring platform 130 is activated to display each returned test result message from the computer platform 10 on the monitor 131 for viewing by the user. If the test result message is “FAIL”, the user can then use the keyboard 132 together with the monitor 131 to check the internal hardware/software configurations of the computer platform 10 to find and fix the problem. On the other hand, if the test result message is “PASS”, the procedure returns to the substep S32 to perform the next test procedure (if any) specified by the procedure description file 121, until the last test procedure in the procedure description file 121 is completed. This completes the auto mode operation of the step S30.

In conclusion, the invention provides a network-based computer platform external access method and system, which is designed for use with an I/O-unequipped computer platform for the purpose of externally controlling the operations of the computer platform and monitoring responses from the same. The network-based computer platform external access method and system of the invention normally allows the user to perform externally-accessed control or test operations on the computer platform; and when it is required to test the internal hardware/software configurations of the computer platform, the invention allows user to perform an externally-monitored auto test procedure on the computer platform by downloading a test procedure description file via a network system from a server for the purpose of automatically testing the internal hardware/software configurations of the computer platform. These features allow the network system management personnel to perform network management tasks on the I/O-unequipped network server more conveniently and efficiently.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A network-based computer platform external access method for use on a computer platform for the purpose of externally controlling the computer platform;
the network-based computer platform external access method comprising:
establishing a network system;
establishing a server for serving up a procedure description file via the network system; and
establishing a terminal monitoring platform equipped with a set of I/O devices and linked via a data communication interface to the computer platform and via the network system to the server;
wherein
the terminal monitoring platform is capable of being linked via the data communication interface to the computer platform to allow an external access to the computer platform;
and wherein
the terminal monitoring platform is further capable of being linked via the network system to the server to download the procedure description file from the server, and subsequently transferring each user-predefined command in the procedure description file via the data communication interface to the computer platform where the user-predefined command is executed to allow an externally-monitored auto operational procedure on the computer platform.

2. The network-based computer platform external access method of claim 1, wherein the network system is Internet.

3. The network-based computer platform external access method of claim 1, wherein the network system is a LAN system.

4. The network-based computer platform external access method of claim 1, wherein the network system is an intranet system.

5. The network-based computer platform external access method of claim 1, wherein the network system is an extranet system.

6. The network-based computer platform external access method of claim 1, wherein the data communication interface is a serial interface.

7. The network-based computer platform external access method of claim 1, wherein the data communication interface is a parallel interface.

8. The network-based computer platform external access method of claim 1, wherein the data communication interface is a USB interface.

9. The network-based computer platform external access method of claim 1, wherein the procedure description file is a test-procedure description file containing a sequence of user-predefined test procedures.

10. A network-based computer platform external access system for use with a computer platform for the purpose of externally controlling the computer platform;
the network-based computer platform external access system comprising:
a network system;
a server, which is linked to the network system, for serving up a procedure description file via the network system; and
a terminal monitoring platform, which is equipped with a set of I/O devices and linked via a data communication interface to the computer platform and via the network system to the server;
wherein
the terminal monitoring platform is capable of being linked via the data communication interface to the computer platform to allow an external access to the computer platform;
and wherein
the terminal monitoring platform is further capable of being linked via the network system to the server to download the procedure description file from the server, and subsequently transferring each user-predefined command in the procedure description file via the data communication interface to the computer platform where the user-predefined command is executed to allow an externally-monitored auto operational procedure on the computer platform.

11. The network-based computer platform external access system of claim 10, wherein the network system is Internet.

12. The network-based computer platform external access system of claim 10, wherein the network system is a LAN system.

13. The network-based computer platform external access system of claim 10, wherein the network system is an intranet system.

14. The network-based computer platform external access system of claim 10, wherein the network system is an extranet system.

15. The network-based computer platform external access system of claim 10, wherein the data communication interface is a serial interface.

16. The network-based computer platform external access system of claim 10, wherein the data communication interface is a parallel interface.

17. The network-based computer platform external access system of claim 10, wherein the data communication interface is a USB interface.

18. The network-based computer platform external access system of claim 10, wherein the procedure description file is a test-procedure description file containing a sequence of user-predefined test procedures.
